(19) United States
(12) Patent Application Publication
(10) Pub. No.: US 2010/0326067 A1
(43) Pub. Date: Dec. 30, 2010

(54) SELF-PROPELLED MACHINE

(75) Inventors: Ralf Weiser, Ladenburg (DE); Tobias Noll, Roschbach (DE); Andreas Letz, Mannheim (DE); Martin Buschmann, Neustadt (DE)

Correspondence Address: FISH & RICHARDSON P.C. (NY), P.O. BOX 1022, MINNEAPOLIS, MN, 55440-1022, US

(73) Assignee: JOSEPH VOGELE AG, Mannheim (DE)

(21) Appl. No.: 12/821,925

(22) Filed: Jun. 23, 2010

(30) Foreign Application Priority Data
Jun. 29, 2009 (EP) 09008470.8

(51) Int. Cl. F16D 33/00; F16D 31/02

(52) U.S. Cl. 60/329; 60/396; 60/456

(57) ABSTRACT

In a self-propelled machine F for processing paving material, the machine having a liquid cooled combustion engine M and at least one hydraulic circuit H containing hydraulic pumps 6, hydromotors or hydrostatic drive units 7-10 and at least one hydraulic medium reservoir 12, a fan assisted cooling device K including cooling regions 1b, 1c at least for the cooling liquid of the combustion engine M and of the hydraulic medium of the hydraulic circuit H. A hydraulic medium operation temperature setting and regulating device R is provided for the hydraulic medium cooling region 1c constituted by a separate cooler 24 in order to generate an operation temperature T of the hydraulic medium above at least about 60° C. and to maintain this operation temperature depending on the hydraulic load situation in the hydraulic liquid H and on the surrounding climate, independently from a cooling regulating system S for the combustion engine M.

The invention relates to a self-propelled machine for processing bituminous or concrete paving material, in particular a road paver or road paver feeding vehicle.

A drive concept for functional components and working components has become standard for such machines, in particular for road pavers and road paver feeding vehicles. The combustion engine serves as a primary drive source, however, the functional components and working components exclusively or almost exclusively are operated hydraulically e.g. by means of hydrostatic driving units. At least one cover layer having varying width is laid on the planum by a road paver, which evens and compacts the cover layer. The road paver feeding vehicle stores a sufficiently large amount of paving material and feeds the paving material to the road paver such that the road paver is able to work continuously, while the road paver feeding vehicle and the trailing road paver are travelling at low working travelling speed on the planum, e.g. with a speed of up to about 20 m/min. In case of transportation travel to another construction site for both machines a transport speed of up to about 20 km/h is conventional. Owing to the processing of hot bituminous paving material or concrete paving material very specific requirements exist for the hydraulic system and the combustion engine, caused e.g. by the consistency of the paving material, the stickiness, the processing temperature, the dragging resistance of the paving material on the planum during the formation of the cover layer or the conveying resistance while transferring the paving material from the road paver feeder vehicle to the road paver. Specific requirements also result from the travelling resistance varying with the construction site surface conditions and with climatic influences. This means that at least some of the hydrostatic driving units have to be extremely powerful, rapidly responsive and able to operate permanently while at the same time they need to be individually regulated. These requirements need strong hydraulic pumps, at least partially long hydraulic paths between the hydraulic pumps and the hydrostatic driving units, and a consideration of high safety and environmental protection standards. A road paver or a road paver feeding vehicle having a total weight of about 20 tons contains a significant volume of hydraulic medium in the hydraulic circuits, e.g. up to 400 litres or even more. Conventional hydraulic media for such machines (e.g. of the specification: HLP 46 according to DIN 51524, part 2) show a behaviour of the kinematic viscosity over the temperature according to which the viscosity first degressively decreases when the temperature increases to about 60° C. The viscosity remains very low around about 100° C. However, temperatures of about 100° C. are critical in particular for sealings and hoses in the hydraulic circuits of such self-propelling machines. At about 60° C. the viscosity is only about half as high as at 40° C. and is only about one-tenth of the viscosity at about 0° C. Between about 75° C. to 80° C. the viscosity even amounts to about one-fifth of the viscosity at 40° C. The lower the viscosity of the hydraulic medium is the lower the pump losses are and the more responsive and more efficiently the hydrostatic operating units and the hydraulic pumps operate. The combustion engine serving as the primary driving source has to compensate for the pumping losses. The combustion engine operates e.g. during normal operation with a nominal power of about 160 kW at about 2,000 U/min. The pumping losses deteriorate the energy efficiency or energy balance of the self-propelled machine markedly and offer a significant potential for savings of primary energy like diesel fuel considering the average operation hours of such a machine per year.

As e.g. known from the leaflet “Super 1603-1” of the company Joseph Vögele AG, 68146 Mannheim, Del., pages 4, 5, a large multiple field cooler is provided as a cooling device for the engine cooling water of the combustion engine, for the hydraulic medium, and in this case also for the supercharging air of the e.g. supercharged diesel engine. The cooling device assures permanently optimal engine operation temperature and 100% motor power even under full operational load and elevated outside temperatures up to 50° C. The cooling device comprises at least one fan which e.g. is operated in dependence on the engine speed. Traditionally, the cooling device is designed for the combustion engine. Since the hydraulic medium cooling region of the cooling device has to be designed such that even under extreme operating conditions overheating of the hydraulic medium is prevented reliably, while on the other hand the cooling regulation of the cooling device is executed with a view to the optimal operation temperature of the combustion engine only, the hydraulic medium is cooled during e.g. more than 95% of the operation duration such that the operation temperature of the hydraulic medium does not exceed about 40° C. The temperature dependent viscosity properties of the hydraulic medium thus lead to a waste of a significant part of the engine's nominal power, which nominal power per se is generated for processing the paving material, as the combustion engine then has to compensate for unduly high pumping losses of the hydraulic medium.

Owing to a long-standing, but exaggerated safety philosophy the importance of the viscosity properties of the hydraulic medium for the energy balance or energy efficiency of the combustion engine of such self-propelled machines for processing bituminous or concrete paving material has not been considered in practice until now. However, on the other hand, recent developments exist to relieve the environment when operating such machines (in view of global warming, reduction of emissions of CO2 and NOₓ, and savings of non-renewable energy carriers).

EP 1 741 893 A discloses a common cooling device for cooling water and hydraulic oil. A common fan driven by a hydromotor is functionally associated to the cooling device. The cooling device is regulated such that the cooling water reaches a target temperature as fast as possible at a predetermined combustion engine speed which target temperature is then maintained constant while at the same time the operation temperature of the hydraulic oil is brought to the same temperature of about 80° C. corresponding to the temperature of the cooling water. In case of an increased cooling demand of the cooling water consequently the hydraulic oil, in some cases, may be cooled too much.

In a cooling system known from U.S. Pat. No. 6,076,488 A the cooling region for the hydraulic medium and the cooling region for the cooling water are arranged in series in flow direction of the airstream generated by a common fan driven by a hydromotor such that the hydraulic medium is permanently cooled stronger than the cooling water. For the respective operation temperatures target values are predetermined and will be maintained such that the hydraulic medium is permanently somewhat cooler than the cooling water. Increased cooling demand of the cooling water consequently means an even stronger cooling of the hydraulic medium irrespective of hydraulic load in the hydraulic system.

Further prior art can be found in U.S. Pat. No. 4,785,915 A, WO 2006/046902 A, DE 44 39 454 A and EP 1 870 576 A.

It is an object of the invention to provide a self-propelled machine for processing bituminous and/or concrete paving material, the combustion engine of which machine may be operated with an improved energy balance or energy efficiency despite the specific requirements dictated by the complicated processability of the paving materials, and which saves fuel to marked extent and protects the environment.

This object is achieved by the self-propelled machine of the present invention.

Thanks to the hydraulic medium operation temperature setting and regulating device the operation temperature of the hydraulic medium first is increased as rapidly as possible and then is regulated within an operation temperature range at which due to low viscosity the additional load of the combustion engine e.g. caused by pumping losses of the hydraulic medium is minimised. This means intentionally neglecting conventional concepts according to which e.g. for reasons of operational safety the operation temperature of the hydraulic medium was kept extremely low, but factually does not increase risks for the operational safety, since the hydraulic medium operation temperature setting and regulating device reliably maintains the selected operation temperature range. The cooling power is regulated depending on the hydraulic load condition and the surrounding climate. The cooling power is only maximised if a tendency occurs to exceed the set hydraulic medium operation temperature range, e.g. in a case when at high outside temperatures, low air humidity and unfavourable processing conditions of the paving material and complicated ground conditions and vehicle travelling conditions the machine has to make an operation pause, e.g. while waiting for a delivery of fresh paving material, with the combustion engine operating in idle condition, automatically meaning less cooling power for the combustion engine. In this case the hydraulic medium operation temperature setting and regulating device regulates to e.g. maximum cooling capacity independent from the temporarily reduced cooling demand of the combustion engine in order to reliably prevent overheating of the hydraulic medium. Seen in total, in this fashion a significant amount of fuel can be saved over the service time of the machine in normal operation and per year. The improvement of the energy efficiency of the combustion engine is paired with an optimised operation of the hydraulic pumps and the hydrostatic driving units and a permanently rapid response behaviour in the hydraulic circuit. Optionally, without drawbacks for the processing of the paving material even a combustion engine may be implemented which has less power and optimised fuel consumption. The hydraulic medium cooling region is a separate hydraulic medium cooler structurally separated from the cooling liquid cooling region. A fan or blower is functionally associated to this separated cooler only. The speed of the fan may be regulated and/or the fan may be switched on and off upon demand of the hydraulic medium. The fan is connected with the hydraulic medium operation temperature setting and regulating device. By separately arranging the hydraulic medium cooler situations may be avoided where e.g. unavoidably the hydraulic medium cooler is heated or cooled from the surroundings. Such situations could occur if the cooling liquid cooling region and the hydraulic medium cooler were to be situated close to each other.

Furthermore, this concept may be of advantage in the machine in order to meet restricted or narrow mounting space situations at the location of the cooling liquid cooling region and/or to improve the weight distribution in the machine chassis. The fan has in an expedient embodiment, at least for the hydraulic medium cooling range, a hydraulic or electric drive motor. The power output and the regulation of the drive motor in this case may be adjusted or regulated independently from the speed of the combustion engine. For regulating the optimal hydraulic medium operation temperature range and/or for rapidly heating up to the desired hydraulic medium operation temperature independent from the engine cooling power it maybe expedient to arrange a thermostatic valve or a valve which is actuated by the hydraulic medium operation temperature setting and regulating device in a bypass deviating in the hydraulic circuit the hydraulic medium cooling region The bypass facilitates that the hydraulic medium at least temporarily to completely deviates the hydraulic medium cooling region when the machine is operating under normal operation conditions and as long as the hydraulic medium is too cold. The bypass may also be used in case of implementing a heating device for heating-up the hydraulic medium in the hydraulic circuit or in the hydraulic circuitries more rapidly.

In an expedient embodiment the hydraulic medium operation temperature setting and regulating device operates independent from the engine cooling regulating system as it is connected with at least one hydraulic medium temperature sensor and/or information transmitter indicating the hydraulic load condition in the hydraulic circuit and the surrounding climate. For example in case of cool surrounding temperatures with the combustion engine operating at nominal speed with maximum cooling power for the cooling water the cooling power for the hydraulic medium may be reduced drastically or even may be switched off totally in order to achieve and maintain optimum viscosity of the hydraulic medium. On the other hand the individual regulation of the operation temperature of the hydraulic medium facilitates to cope with momentary or temporary disadvantageous hydraulic load situations or ambient climate situations and to optimally adjust and maintain the operation temperature of the hydraulic medium, even if then, in some cases, the engine cooling regulation system responds differently. Additional structural efforts needed for the hydraulic medium operation temperature setting and regulating device and the temperature sensors and/or information transmitters needed for the operation of the device are negligible in view of the high fuel saving potential of the combustion engine without endangering the operational safety despite the difficult requirements for the hydraulic system during the processing of paving material. Even several tons of fuel can be saved per year and machine.

In an expedient embodiment the hydraulic medium operation temperature setting and regulating device includes a programming and/or setting section for the respective optimal hydraulic medium operation temperature. The hydraulic medium then is only cooled so far that it maintains the optimal viscosity, irrespective of how the engine cooling regulation system is operating.

In a preferred embodiment a selecting device is provided, preferably in the programming and/or setting section, in order to select an operation temperature of about 75° C. to which cold hydraulic medium has to be warmed up, and/or to select an operation temperature range from about 75° C. to 80° C., preferably up to almost 90° C., which is to be maintained after warm-up. By virtue of this operation temperature of the hydraulic medium and of this operation temperature range which is then maintained during normal operation, the viscosity of the hydraulic medium is optimised to become as low as possible in order to minimise additional loads for the combustion engine caused by the operation of the hydraulic system. This allows to save even more fuel.

As it may, in some cases, not be sufficient to only cool the hydraulic medium as little as possible to achieve optimal low viscosity in case of unfavourable surrounding climate conditions, e.g. in case of low surrounding temperatures or the like, and in case of a low processing rate of paving material, which can be processed very easily, i.e. causes moderate hydraulic load situations only e.g. when producing a thin cover layer. A further preferred embodiment comprises in the hydraulic circuit even at least one hydraulic medium heating device. The heating device may be connected to the hydraulic medium operation temperature setting and regulating device and may be operated via the device, however, alternatively, may be operated independently e.g. with a timing circuitry or guided by an operator. The heating device does not only allow to heat up cold hydraulic medium as rapidly as possible to the optimal operation temperature, but may be used for maintaining the optimal operation temperature range during normal operation of the machine. This may be advantageous in a case where the desired elevated operation temperature of the hydraulic medium cannot be adjusted or maintained solely by minimising cooling power or switching the cooling power off.

In an expedient embodiment a hydraulic medium heating device is provided at or within the hydraulic medium reservoir. Alternatively, the heating device may be arranged at any suitable location of the at least one hydraulic circuit, e.g. in a bypass. The reservoir conventionally stores a maximum quantity of hydraulic medium, e.g. about 400 litres. The hydraulic medium in the reservoir is under relatively moderate return pressure, meaning that the heating device will operate efficiently and does not need to be designed to withstand high pressures.

In an expedient embodiment protecting the environment the hydraulic medium heating device is operated by use of the cooling water of the combustion engine and/or electrically via a generator driven by the combustion engine and/or by waste heat at least of the combustion engine. This concept further improves the energy efficiency of the combustion engine as the used heating energy is available anyhow and e.g. may be taken easily from the cooling water or the waste heat, which available heating energy otherwise would be released into the surroundings.

The cooling device of an expedient embodiment comprises a combination cooler (e.g. a multi-field cooler or a set of separated coolers). A fan is commonly associated to the cooling water cooling region and the hydraulic medium cooling region of the combination cooler. The fan, preferably, may be driven proportionally to the speed of the combustion engine. In order to regulate the cooling power for the hydraulic medium independent from the engine cooling power an adjustable airstream shielding or deflecting assembly may be arranged in the airstream from the fan to the hydraulic medium cooling region. The assembly, preferably, is in functional connection with the hydraulic medium operation temperature setting and regulating device. As soon as the cooling power generated for the cooling liquid tends to become too high for the hydraulic medium to adjust and maintain the desired elevated operation temperature of the hydraulic medium, only the cooling power for the cooling region of the hydraulic medium is reduced via the airstream shielding or deflecting assembly until the desired operation temperature of the hydraulic medium is reached. In order to maintain the desired operation temperature range of the hydraulic medium then the action of the shielding or deflecting assembly may be disabled or regulated accordingly. This does not influence the respectively needed cooling power, e.g. for the cooling water of the combustion engine, or for the intake air or the supercharging air.

In another embodiment the fan or blower of the hydraulic medium cooling region has a hydraulic or electric drive motor. Power output and/or the regulation of the drive motor of the fan may be executed independently from the speed of the combustion engine.

Expediently a circulation pump is provided in the hydraulic medium cooling region or adjacent to the hydraulic medium cooling region. The circulation pump may be controlled by the hydraulic medium operation temperature setting and regulating device. The circulation pump, preferably, is arranged in a shortcut section of the respective hydraulic circuit e.g. between the reservoir and the hydraulic medium cooling region. The circulation pump e.g. allows to vary the flow rate of the hydraulic medium depending on the cooling demand in order to intensify or minimise the cooling effect, respectively.

At least one signal transmitter for the actual temperature of the hydraulic medium and/or thermal load situation at least one selected hydraulic pump and/or a selected hydrostatic drive unit is provided in an expedient embodiment. The signal transmitter signals the hydraulic load situation in at least a load critical location of the hydraulic circuit and may function as a regulation command variable transmitter connected with the hydraulic medium operation temperature setting and regulating device. In this case, expediently, a hydraulic pump and/or a hydrostatic drive unit is selected which is extremely powerful or for which extreme hydraulic operation situations are to be expected, such that the hydraulic medium operation temperature setting and regulating device is permanently informed rapidly on a critical condition and is able to immediately regulate accordingly.

In another embodiment a computerised main control system of the machine may be provided as a signal transmitter for at least hydraulic and/or thermal load situations at least one selected hydraulic pump and/or a selected hydrostatic drive unit. The main control system, in most cases, is informed about the current load requirements of the hydraulic pump and/or of the hydrostatic drive unit, e.g. because certain operation conditions are set in the main control system. In this case the main control system may inform the hydraulic medium operation temperature setting and regulating device in real time or even in a preparatory fashion in order to preparatorily and reliably prevent overshooting of the operation temperature of the hydraulic medium. Another operation situation, about which the main control system may inform the regulating device is an expected operation stop of the machine, e.g. the end of a work duration or in case of an upcoming pause while the machine is waiting for a delivery of fresh paving material. Here, an operator may have made corresponding preparations at the main control system, according to which e.g. the hydrostatic drive units and the combustion engine will become regulated down. As then the hydraulic medium operation temperature setting and regulating device is informed early about this upcoming operation condition change, in some cases the hydraulic medium may even by cooled more intensively in order to counteract overshooting of the operation temperature of the hydraulic medium when the operation pause starts.

Basically, according to the invention, a machine for processing bituminous and/or concrete paving material by use of a combustion engine, specifically a diesel engine, as a primary drive source for at least one hydraulic system including hydraulic pumps and hydrostatic drive units, is operated such that for improving the energy efficiency of the combustion engine under operation or starting with the start of the operation of the machine, the hydraulic medium is brought as rapidly as possible to an elevated operation temperature of at least about 60° C. and is then regulated in an operation temperature range of above about 60° C. depending on the hydraulic load condition in the at least one hydraulic circuit and depending on the surrounding climate, but independent from the load condition of the combustion engine and the engine cooling regulation. This allows to waste as little as possible of the compensation power of the combustion engine due to optimal low viscosity of the hydraulic medium, and to save as much fuel as possible.

Embodiments of the invention will be explained with the help of the drawings. In the drawings is:

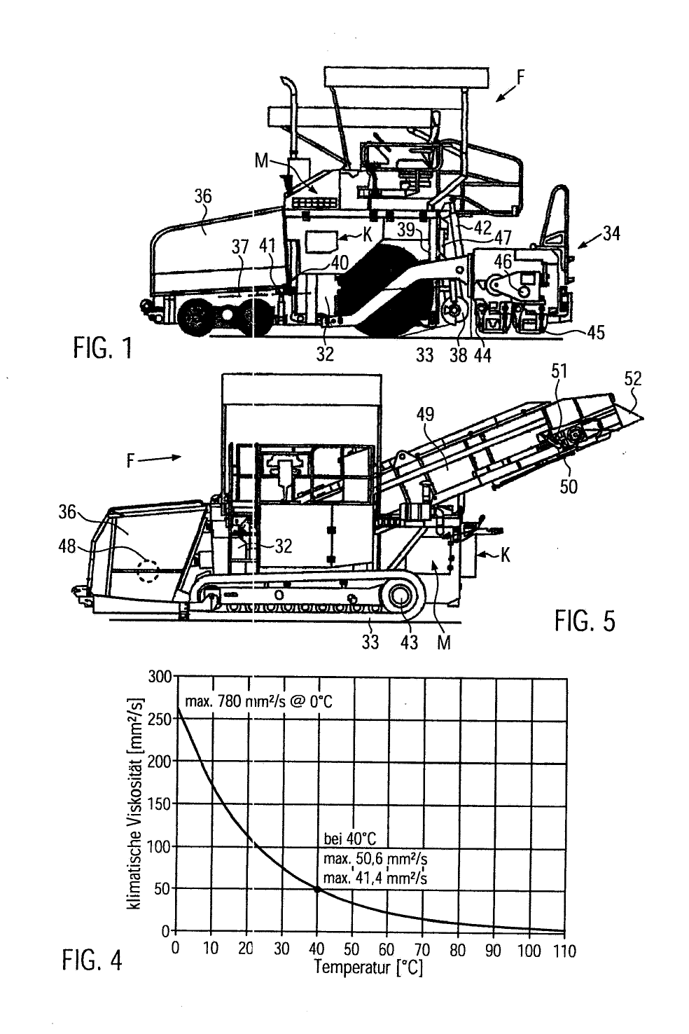

FIG. 1 a schematic side view of a self-propelled machine for processing paving material, in particular a road paver,

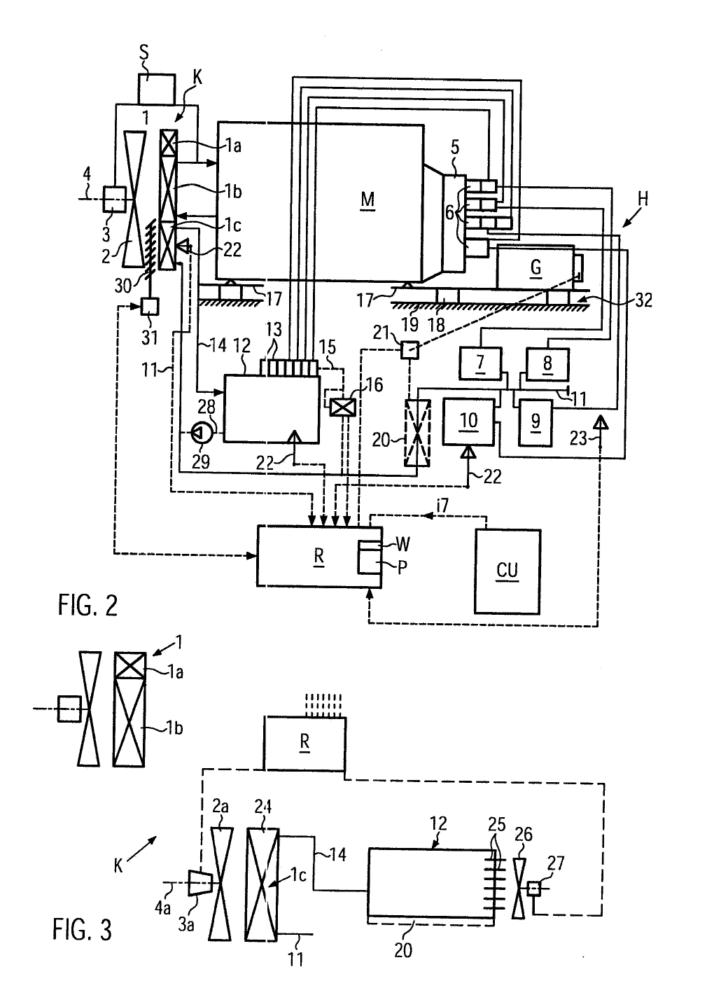

FIG. 2 a schematic block diagram of a hydraulic drive concept of the machine,

FIG. 3 a detail variant of FIG. 2,

FIG. 4 a diagram of the kinematic viscosity of a hydraulic medium over the operation temperature, and

FIG. 5 a schematic side view of another machine for processing paving material, namely a road paver feeding vehicle.

FIG. 1 shows as an example of a self-propelled machine F of a road paver for processing bituminous and/or concrete paving material when producing cover layers e.g. of traffic surfaces or the like.

The machine F has a chassis 32 with an undercarriage 33 comprising in the shown embodiment wheels (alternatively a caterpillar track undercarriage) and a combustion engine M, e.g. a diesel engine, as a primary drive source. The machine F, furthermore, has a plurality of functional components and working components which predominantly are operated hydraulically and are supplied with driving power from the combustion engine M. A material hopper 36 is provided on the chassis 32. A longitudinal conveying device 37 extends from the material hopper 36 in the chassis 32 to the rear chassis end, where a lateral distribution assembly 38 with height adjustment means 47 and a drive 39 are provided. A paving screed 34 is linked to the chassis 32. The angle of attack of the paving screed 34 can be adjusted by levelling cylinders 41 which are anchored to the chassis 12. The paving screed 34 may be lifted totally by hydraulic cylinders 42 anchored to the rear end of the chassis 32. The paving screed 34 contains adjustment cylinders 46, hydraulically actuated tampers 44 and hydraulically operated, optional, pressing bars 45. Hopper side wall adjustment cylinders 42 are arranged at the material hopper 36. A cooling device K is functionally associated to the combustion engine M. The cooling device K e.g. may be a multiple field cooler and includes at least one fan. The fan, e.g., may be driven proportional to the speed of the combustion engine M.

The above-mentioned functional components and working components of the machine F are operated for processing the paving material by means of hydrostatic drive units or hydraulic cylinders. For this reason at least one hydraulic circuit H (FIGS. 2, 3) is provided containing hydraulic pumps and valve arrangements. The different hydraulic pumps e.g. are driven via a distribution gear mechanism for pumps by the combustion engine M. Furthermore, a generator G is driven in order to provide electric power for electric consumers, e.g. heating devices in the region of the longitudinal conveying device 37, at the tampers 44, at the pressing bars 45, and at sole plates of the paving screed 34. In addition, a reservoir 12 for hydraulic medium (hydraulic oil) is provided for the hydraulic circuit or the hydraulic circuits which include connection pipings and connection hoses. The reservoir 12 may have a storing capacity of several hundred litres. The cooling device K is designed such that both the cooling liquid of the combustion engine M, in some cases even intake air or supercharging air, and the hydraulic medium are cooled. A cooling regulating system S is provided which primarily regulates the cooling effect for the cooling liquid of the combustion engine M such that the combustion engine M in normal operation (e.g. at a nominal speed of about 2000 U/min at a nominal power of about 160 kW) operates permanently at an optimum operation temperature.

In order to assure that the still cold hydraulic medium reaches an operation temperature of at least about 60° C., preferably between about 75° C. and 80° C. or a little bit more as rapidly as possible, and that then a hydraulic medium operation temperature range of e.g. 75° C. to 80° C. is maintained during normal operation of the machine F independent from conditions of the ambient climate, a hydraulic medium operation temperature setting and regulating device R (as shown in FIG. 2) is provided in the machine F for, preferably, regulating the operation temperature of the hydraulic medium independent from the cooling regulating system S for the cooling liquid of the combustion engine M.

Either a multiple field cooler or a cooler set 1 consisting of several coolers is functionally associated to the combustion engine M, e.g. a diesel engine. The multiple field cooler or the cooler set 1 comprises in the shown embodiment a cooling region 1a for the intake air or supercharging air, a cooling region 1b for the cooling liquid of the combustion engine M, and a cooling region 1c for the hydraulic medium. A common fan 2 having a drive motor 3 is provided and is controlled by the cooling regulating system S with a view to the optimal operation temperature of the combustion engine M. Reference number 4 indicates the energy supply to the drive motor 3. The drive motor 3 e.g. may be supplied from the hydraulic system, or may be supplied with electric power by the generator G driven by the combustion engine M, or even may be driven directly or indirectly by the crankshaft of the combustion engine M.

A distribution gear mechanism for pumps 5 is flanged to the motor block of the combustion engine M in FIG. 2. Several hydraulic pumps 6 are mounted to mechanical power outlets of the distribution gear mechanism for pumps 5. The hydraulic pumps 6 are connected hydraulically via connecting pipings or pressure hoses with various hydrostatic drive units 7, 8, 9, 10 for actuating the working components and functional components of the machine F as explained in connection with FIG. 1. A common return line 11 extends e.g. from the hydrostatic drive unit 7-10 to a hydraulic medium reservoir 12, conventionally a metal container having a large volume, to which reservoir e.g. valve components 13 may be attached. The reservoir 12 may be connected via a piping 14 with the cooling region 1c. The return line 11 as well may be connected to the cooling region 1c. A bypass 15 may be provided between the reservoir 12 or the valve arrangement 13 and the return line 11 in which bypass 15 a thermostatic valve 16 or a valve 16 controlled by the regulating device R may be provided for the hydraulic medium flow. The bypass 15 deviates the cooling region 1c.

The combustion engine M is arranged on an engine console 17 supported in vibration isolating fashion via engine bearings 18 on supports 19 of the chassis 32 of the machine F. The generator G which, e.g. (not shown) is driven from the distribution gear mechanism for pumps 5, may be supported on the engine console 17 as well.

In the shown embodiment of FIG. 2 optionally at least one heating device 20 may be provided for the hydraulic circuit or for all hydraulic circuits H of the hydraulic system, e.g. in the return line 11 or within or at the reservoir 12, in the bypass 15 or at another suitable location at the machine F. In FIG. 2 the heating device 20 e.g. is operated electrically from the generator G via a control system 21 which in turn is controlled by the regulating device R. Alternatively or additively the heating device 20 could use cooling water and/or waste heat at least of the combustion engine M.

At least one selected hydrostatic drive unit or at several or even at all hydrostatic drive units 7-10 (or at the hydraulic pumps 6) or at other suitable locations of the hydraulic circuit H a temperature sensor 22 may be provided for detecting the operation temperature of the hydraulic medium (or a sensor transmitting the hydraulic load condition), and is connected to the regulating device R. Such a temperature sensor 22 may be provided as well at or within the reservoir 12 or within or at the cooling region 1c. Furthermore, at least one information transmitter 23, e.g. a temperature sensor and/or humidity sensor, may be provided and connected with the regulating device R for detecting the surrounding climate.

A, preferably, computerised main control system CU of the machine F as well may be connected with the regulating device R (or may be united with the same) in order to provide information i7 e.g. of the hydraulic load conditions of the selected hydrostatic drive unit 7 in real time or even in preparatory fashion.

The hydraulic medium operation temperature setting and regulating device R comprises a programming and/or setting section P at which e.g. the desired operation temperature of the hydraulic medium can be set and monitored and, expediently, a selecting device W at which hydraulic medium operation temperature of at least about 60° C., preferably even about 75° C., may be set, and as well an operation temperature range for normal operation of the machine F of at least about 60° C. can be set and monitored, preferably about 75° C. to 80° C., or more, preferably, even up to almost 90° C. After operation start cold hydraulic medium has to be brought as rapidly as possible to the desired hydraulic medium operation temperature. During normal operation of the machine while processing paving material the operation temperature of the hydraulic medium then has to be maintained within the operation temperature range, independent of how the cooling regulating system S is regulating the cooling effect at least for the cooling liquid for the combustion engine M.

In a shortcut circuit 28, e.g. extending between the cooling region 1c and the reservoir 12 or the hydraulic circuit H a circulation pump 29 may be inserted.

Because the fan 2 in FIG. 1 is commonly associated to all cooling regions 1a, 1b, 1c; expediently at least one shielding or deflecting assembly 30 is provided in the air flow path from the fan 2 to the cooling region 1c for the hydraulic medium. By virtue of the shielding or deflection assembly 30 the cooling power generated by the fan 2 is regulated individually for the cooling region 1c, e.g. via an actuator 31 which is controlled by the regulating device R, or, as well, (not shown) by at least one thermostat or another temperature sensor in the hydraulic circuit H. The shielding or deflection assembly 30 e.g. could comprise flaps, lamellas or other elements controlling the air flow, optionally to a full blockage.

During operation of the machine F and while the combustion engine M is running the operation temperature of the still cool hydraulic medium in the hydraulic circuit H is first elevated to an operation temperature of at least about 60° C. which is optimal in view of the viscosity of the hydraulic medium and is then maintained in the operation temperature range of above about 60° C. which is also optimal in view of the viscosity in order to assure a rapid response of the hydraulic pumps 6 and/or the actuated hydrostatic driving units 7-10, and in order to minimise pumping losses in the hydraulic circuit H which otherwise the combustion engine M has to compensate for by additional fuel consumption. The operation temperature of the hydraulic medium is regulated independent from the regulation process of the cooling regulating system S at least for the cooling liquid of the combustion engine M and depending on the hydraulic load situations in the hydraulic circuit H, specifically at the hydraulic pumps 6 and/or the hydrostatic drive units 7-10. The hydraulic load situations, preferably, are detected at a selected hydraulic pump or drive unit, by which e.g. the highest driving power is consumed or at which the strongest load variations occur.

FIG. 3 illustrates a detail variant according to which the cooling region 1c for the hydraulic medium is structurally separated from the cooling regions 1a and 1b of the cooling device 1. The cooling region 1c is constituted by a separate hydraulic medium cooler 24 which e.g. is connected to the return line 11 and to the connection line 14 leading to the reservoir 12. Functionally associated to the cooling region 1c, i.e. the cooler 24, is a fan 2a having its own drive motor 3a and its own driving power supply 4a. The fan 2a may be operated via the regulating device R, as shown, or operated only by a thermostatic control or in dependence from the measuring result of a temperature sensor in the hydraulic circuit H. The drive motor 3a either may be a hydromotor or an electric motor or is (not shown) driven by the crankshaft of the combustion engine M, e.g. via a disengageable clutch. The cooler 24 may be placed in the cooling device K or at a suitable position within the machine F.

FIG. 3 also illustrates a further detail variant according to which cooling fins 25 are provided at the reservoir 12. Furthermore, another fan 26 having a drive motor 27 may be provided there which drive motor 7 as well e.g. is controlled by the regulating device R in order to additionally cool the hydraulic medium within the reservoir 12 upon demand. Optionally (FIG. 3) even the heating device 20 may be arranged at or within the reservoir 12 in order to additionally heat the hydraulic medium upon demand, e.g. in order to reach the desired operation temperature of at least 60° C. or somewhat more as rapidly as possible, and/or to reliably maintain the desired operation temperature range of above 60° C. The heating device 20 alternatingly may be provided in the bypass 15 or the shortcut circuit 28.

The diagram in FIG. 4 illustrates for a conventional hydraulic medium (e.g. a hydraulic oil of the specification HLP 46 according to DIN 51524, part 2) the behaviour of the kinematic viscosity KV as shown on the vertical axis over the operation temperature T shown on the horizontal axis. At an operation temperature of about 60° C. the kinematic viscosity amounts to only about half of the kinematic viscosity at an operation temperature of about 40° C. and amounts to substantially less than a tenth of the viscosity at about 0° C. In the operation temperature range between 70° C. and about 80° C. the viscosity amounts to about only half of the viscosity at 60° C. This behaviour of the viscosity of the specified hydraulic medium (other conventional hydraulic media for machines for processing paving material show a similar behaviour of the kinematic viscosity over the operation temperature) allows to improve the energy efficiency of the combustion engine M in the machine F of FIGS. 1 to 3, and also in the machine F in FIG. 5 by first adjusting the relatively high operation temperature of at least about 60° C. and furthermore maintaining an operation temperature range of above about 60° C., i.e. by intentionally regulating the temperature such that the viscosity will be optimal. The improved energy efficiency saves fuel due to the fact that the hydraulic medium is individually cooled and/or heated independent from the engine cooling.

FIG. 4 illustrates a machine F for processing paving material, namely a road paver feeding vehicle which is travelling in front of the respective road paver on the planum and supplies stored paving material to the hopper 36 of the road paver of FIG. 1. The road paver feeding vehicle may be supplied with paving material either intermittently from dump trucks or continuously by a continuously operating conveying device. The road paver feeding vehicle permanently supplies sufficient paving material to the material hopper 36 of the road paver such that the road paver is able to continuously form a cover layer.

The road paver feeding vehicle shown in FIG. 5 has the undercarriage 33, e.g. a caterpillar track undercarriage, at a chassis 32 and at least one hydrostatic drive unit 43, and a large material hopper 36. The road paver feeding vehicle is a self-propelled vehicle and contains as a primary drive source a liquid cooled combustion engine M, e.g. a diesel engine. A cooling device K is provided at least for the cooling liquid of the combustion engine M. A hydraulically operated lateral conveying device 48 may be arranged in the material hopper 36. An ascending hydraulically operated longitudinal conveying device 49 extends from the lateral conveying device 48 rearwardly and upwardly to a hydraulically adjustable supplying end 52. A further hydraulic assembly 50 may be part of the conveying device 49. The road paver feeding vehicle as the machine F processing paving material e.g. contains hydrostatic drive units for the travelling drive 43, the lateral conveying device 48, furthermore, not shown, hopper side wall adjustment cylinders, the assembly 50 and the supply end 51. All hydraulic working components and function components are operated via hydraulic pumps within at least one hydraulic circuit with the pumps being driven by the combustion engine M. The cooling device K may be designed according to FIG. 2 or FIG. 3 with the separate cooler 24 and such that first a hydraulic medium operation temperature of at least about 60° C. is adjusted depending on the hydraulic load situations and the ambient climate but independent from the cooling effect for of the cooling liquid of the combustion engine M. Then a hydraulic medium operation temperature is maintained within a hydraulic medium operation temperature range of above about 60° C., preferably between 75° C. and 80° C., in order to optimise the response behaviour of the components in the hydraulic circuits, by reducing the viscosity of the hydraulic medium and to reduce the fuel consumption of the combustion engine M such that the combustion engine both drives the road paver feeding vehicle and actuates the hydraulic working components and function components more efficiently.

1. Self-propelling machine for processing bituminous or concrete paving material comprising a liquid cooled combustion engine as a primary driving source and at least one hydraulic circuit containing hydraulic pumps, hydromotors or hydrostatic units for function components and working components of at least the machine, and at least one hydraulic medium reservoir, a fan assisted cooling device having cooling regions at least for the cooling liquid of the combustion engine and for the hydraulic medium in the hydraulic circuit, and a cooling regulating system at least for the cooling region of the cooling device, a device for setting and regulating hydraulic medium operation temperature for the hydraulic medium cooling region to bring the operation temperature of the hydraulic medium to an operation temperature above at least about 60° C. and to maintain the operation temperature of the hydraulic medium in an operation temperature range of at least about above 60° C., and wherein the hydraulic medium cooling region is at least one hydraulic medium cooler having a fan that can be switched on and off and the speed of which can be regulated, the hydraulic medium cooler being structurally separated from the cooling liquid cooling region, the fan of the hydraulic medium cooler being connected with the device for setting and regulating hydraulic medium operation temperature, and a thermostatic valve or a valve controlled by the hydraulic medium operation temperature setting and regulating device is arranged in the hydraulic circuit within a bypass deviating from the hydraulic medium cooler.

2. Self-propelling machine according to claim 1, wherein the hydraulic medium operation temperature setting and regulating device is connected independent from the cooling regulating system for the cooling liquid of the combustion engine to at least one hydraulic medium temperature sensor and/or information transmitter for detecting and signalling the hydraulic load situation in the hydraulic circuit and for the ambient climate condition.

3. Self-propelling machine according to claim 1, wherein the hydraulic medium operation temperature setting and regulating device comprises a programming and/or setting section for the hydraulic medium operation temperature.

4. Self-propelling machine according to claim 3, wherein, a selecting device is provided in the programming and/or setting section of the hydraulic medium operation temperature setting and regulating device, for selecting a warm-up operation temperature of about 75° C. for the hydraulic medium and for selecting an operation temperature range of between about 75° C. and up to about 90° C. which operation temperature range is to be maintained during normal operation of the machine.

5. Self-propelling machine according to claim 1, wherein at least one hydraulic medium heating device is provided in the hydraulic circuit and connected with the hydraulic medium operation temperature setting and regulating device.

6. Self-propelling machine according to claim 5, wherein the hydraulic medium heating device is arranged at or within the reservoir.

7. Self-propelling machine according to claim 5, wherein the hydraulic medium heating device is operated by the cooling liquid of the combustion engine and/or electrically via a generator driven by the combustion engine and/or by waste heat of at least the combustion engine.

8. Self-propelling machine according to claim 1, wherein the cooling device comprises a combination cooler having several separate coolers comprising the cooling liquid and hydraulic medium cooling regions and at least one common fan which is driven proportional to the speed of the combustion engine, and an adjustable air flow shielding or deflecting assembly located in the air flow path from the fan to the hydraulic medium cooling region, the air flow shielding and/or deflecting assembly being functionally connected with the hydraulic medium operation temperature setting and regulating device.

9. Self-propelling machine according to claim 1, wherein the fan for the separate hydraulic medium cooler has a hydraulic or electric drive motor.

10. Self-propelling machine according to claim 1, wherein a circulation pump is functionally associated with the hydraulic medium cooling region and the circulation pump is controlled by the hydraulic medium operation temperature setting and regulating device, the circulation pump being located within a shortcut circuit of the hydraulic circuit, and the shortcut circuit extending between the reservoir and the hydraulic medium cooling region.

11. Self-propelling machine according to claim 1, wherein at least one signal transmitter for the actual hydraulic medium temperature and/or for hydraulic and/or thermal load conditions is functionally associated with at least one selected hydraulic pump and/or a selected hydromotor or a selected hydrostatic drive unit, and wherein the signal transmitter comprises a regulation command variable transmitter connected with the hydraulic medium operation temperature setting and regulating device.

12. Self-propelling machine according to claim 2, wherein a signal transmitter for at least the hydraulic and/or thermal load conditions of the selected hydraulic pump and/or a selected hydromotor or a selected hydrostatic drive unit comprises a computerised main control system of the self-propelled machine and the main control system is connected in signal transmitting fashion with the hydraulic medium operation temperature setting and regulating device.
